(19) United States
(12) Patent Application Publication
(10) Pub. No.: US 2016/0019793 A1
(43) Pub. Date: Jan. 21, 2016

(54) PROCESSING OF THE DATA OF A FLIGHT PLAN

(71) Applicant: THALES, COURBEVOIE (FR)

(72) Inventors: François FOURNIER, TOULOUSE (FR); Frédéric TRINQUECOSTE, TOULOUSE (FR); Sébastien GUILMEAU, TOULOUSE (FR)

(21) Appl. No.: 14/803,046

(22) Filed: Jul. 18, 2015

(30) Foreign Application Priority Data
Jul. 18, 2014 (FR) 14 01623

(51) Int. Cl. G08G 5/00; B64D 45/00

(52) U.S. Cl. CPC G08G 5/003; G08G 5/0013; G08G 5/0021; B64D 45/00; B64D 2045/0075

(57) ABSTRACT

A computer-implemented method for managing the data of an aircraft flight plan comprises collecting initial data of an operational flight plan from a flight planning system FPS by an electronic device of electronic flight bag EFB type; converting the initial data and communicating the converted data to the avionics system of the flight management system FMS, the FMS being able to compute an avionic flight plan on the basis of the converted data; and retrieving the avionic flight plan data such as processed by the flight management system FMS. Developments describe notably the verification of the security and/or of the integrity of the converted initial data by means of predefined compliance rules; the emulation of avionics protocols and the use of the encipherment of the data. System aspects and software aspects are described.

### CROSS-REFERENCE TO RELATED APPLICATION

This application claims priority to foreign French patent application No. FR 1401623, filed on Jul. 18, 2014, the disclosure of which is incorporated by reference in its entirety.

### FIELD OF THE INVENTION

The invention relates to the field of avionics, and in particular that of mission preparation on the ground, onboard and during the flight.

### BACKGROUND

The pilot of an aircraft uses the flight plan information in several contexts: within the avionics equipment for the FMS (Flight Management System) function, generally on an “EFB” (Electronic Flight Bag) for example of tablet type, with an “Operational Flight Plan” function or an “Electronic Flight Folder” or else by means of a “Chart” function of the EFB. The flight plan information is also contained in the flight preparation system FPS (Flight Planning System), part of which is transmitted to the air traffic control.

The large number of sources of data and the diversity of the uses of the various items of flight plan information generally involve numerous manual and cognitive operations on the part of the flight personnel (for example the mission planner and the pilot of the aircraft). The associated tasks require numerous verifications and validations, in terms of consistency.

In current avionics systems, the flight plan is generally prepared on the ground by the mission planner, for example using a tool called the “Flight Planning System”. A part of the flight plan is transmitted to the air traffic control for validation. Another part of the said flight plan is transmitted to the ground via a server situated onboard the aeroplane by means of a function called the “Operational Flight Plan” or “Electronic Flight Folder”. The flight plan information is entered manually, that is to say item by item and therefore laboriously, into the “Charts” function. The flight plan as such is also input manually by the pilot into the so-called “Flight management” aircraft function in accordance with the guidelines set by the mission planner.

These existing techniques and practices present numerous drawbacks. Firstly, no unified input scheme exists, since to date up to three different schemes for doing this are possible. Per se, the learning times are not rationalized and this heterogeneity may be a source of errors or at the very least of sluggishness. Next, no integrated verification of the inputs (for example of the consistency of the data) exists. These aspects give rise to cognitive overload of the pilot, which is prejudicial to his fatigue since these laborious tasks are generally required just before flight.

A need exists for schemes and systems for optimizing the input of the data of flight plans.

### SUMMARY OF THE INVENTION

There is disclosed a computer-implemented method for managing the data of an aircraft flight plan comprising the steps consisting in collecting initial data of an operational flight plan from a flight planning system FPS by an electronic device of electronic flight bag EFB type; converting the said initial data and communicating the said converted data to the avionics system of the flight management system FMS, the said FMS being able to compute an avionic flight plan on the basis of the converted data; and retrieving or receiving the avionic flight plan data such as processed by the flight management system FMS.

In a development, the flight management system FMS verifies the security and/or the integrity of the converted initial data by means of predefined compliance rules.

In a development, the method furthermore comprises a step of avionics protocol emulation by the flight management system FMS so as to compute an avionic flight plan on the basis of the converted flight plan data.

In a development, the method furthermore comprises a step of comparing the avionic flight plan such as computed by the flight management system FMS with the operational flight plan initial data.

In a development, the electronic device of electronic flight bag EFB type comprises display means and the comparison step of the method comprising the simulation and the display on the said electronic device of electronic flight bag EFB type of the avionic processing of the initial data of the operational flight plan.

In a development, the method furthermore comprises the reception of one or more modifications of one or more initial data of the operational flight plan.

In a development, the method comprises the repetition of one or more steps from among the said steps of collection, conversion, retrieval, communication, comparison or of simulation.

In a development, the method furthermore comprises a step of enciphering the data before dispatch to the flight management system FMS.

In a development, the electronic flight bag EFB is a computer tablet.

There is disclosed a computer program product comprising code instructions making it possible to perform one or more steps of the method, when the said program is executed on a computer.

There is disclosed a system comprising means for implementing one or more steps of the method.

Advantageously, a dialogue between avionics systems and non-avionics systems is made possible, at least in part, by the invention. Advantageously and in particular, the computational flexibility and/or capacity (inherent or offloaded remotely via the Cloud) of a device of EFB type can be exploited for processing the data of the flight plan.

### BRIEF DESCRIPTION OF THE FIGURES

Various aspects and advantages of the invention will become apparent in support of the description of a preferred but nonlimiting mode of implementation of the invention, with reference to the figures hereinbelow:

FIG. 1 illustrates the global technical environment of the invention;

FIG. 2 schematically illustrates the structure and the functions of a flight management system of known FMS type;

FIG. 3 presents an overall view and examples of steps of the method according to the invention;

FIG. 4 details certain examples of steps of the method according to the invention.

### DETAILED DESCRIPTION

Certain technical terms and environments are defined hereinafter.

The acronym (or initials) EFB corresponds to the terminology “Electronic Flight Bag” and refers to onboard electronic libraries. An electronic flight bag (or electronic flight tablet) EFB is a portable electronic device used by flight personnel (for example pilots, maintenance or cabin staff etc.). An EFB can provide the crew with flight information, helping them to perform tasks (with less paper). In practice, it generally entails an off-the-shelf computer tablet. One or more applications allow the management of information for flight management tasks. These general-purpose computing platforms are intended to reduce or replace the reference material in paper form, often found in the hand luggage of the “Pilot Flight Bag” and whose manipulation may be laborious. The reference paper documentation generally comprises the flight manuals, the various navigation maps and the ground operations manuals. This documentation is advantageously rendered paperless in an EFB. Furthermore, an EFB can host software applications specially designed to automate operations conducted manually in normal time, such as for example takeoff performance computations (computation of limit speed, etc.).

Various classes of EFB hardware exist. Class 1 EFBs are portable electronic devices (PEDs), which are normally not used during takeoff and the disembarkation operations. This class of device does not require an administrative process of particular certification or authorization. EFB devices of class 2 are normally disposed in the cockpit, e.g. mounted in a position where they are used in all the flight phases. This class of devices requires prior authorization of use. Class 1 and 2 devices are considered to be portable electronic devices. Fixed installations of class 3, such as computing media or fixed docking stations installed in the cockpit of aircraft, generally demand the approval and a certification on the part of the regulator.

The acronym (or initials) FMS corresponds to the terminology “Flight Management System” and refers to the flight management systems of aircraft. During flight preparation or during rerouting, the crew input various items of information relating to the progress of the flight, typically by using an FMS aircraft flight management facility. An FMS comprises input means and display means, as well as computation means. An operator, for example the pilot or the copilot, can input via the input means information such as RTAs, or “waypoints”, associated with route points, that is to say points vertically above which the aircraft must pass. The computation means make it possible notably to compute, on the basis of the flight plan comprising the list of waypoints, the trajectory of the aircraft, as a function of the geometry between the waypoints and/or of the altitude and speed conditions.

The acronym MMI corresponds to Man-Machine Interface (or HMI, Human Machine Interface). The inputting of the information and the display of the information input or computed by the display means constitute such a man-machine interface. With known facilities of FMS type, when the operator inputs a route point, he does so via a dedicated display displayed by the display means. This display may optionally also display information relating to the temporal situation of the aircraft in relation to the route point considered. The operator can then input and view a time constraint imposed for this route point. Generally, the MMI means allow the inputting and the consultation of the flight plan information.

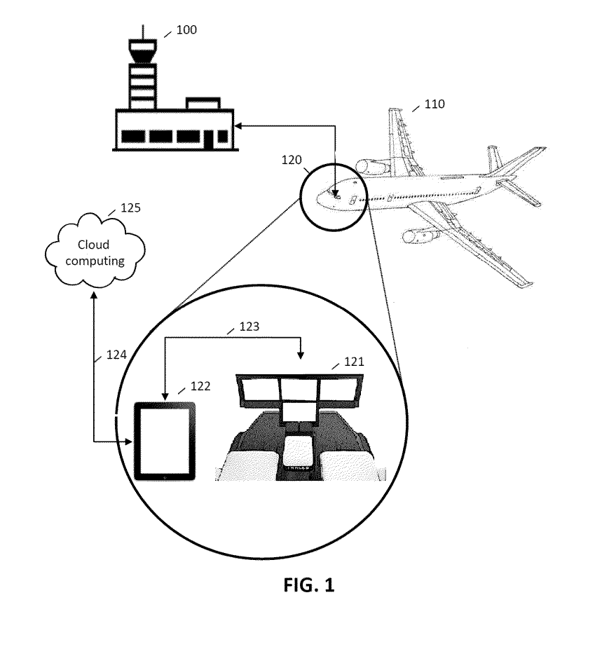

FIG. 1 illustrates the global technical environment of the invention. Avionics equipment or airport means 100 (for example a control tower linked with the air traffic control systems) are in communication with an aircraft 110. An aircraft is a means of transport capable of deploying within the terrestrial atmosphere. For example, an aircraft can be an aeroplane or a helicopter (or else a drone). The aircraft comprises a flight cabin or a cockpit 120. Within the cockpit are situated piloting equipment 121 (so-called avionics equipment), comprising for example one or more onboard computers (means of computation, of saving and of storing data), including an FMS, means of display or viewing and inputting of data, communication means, as well as (optionally) haptic feedback means. An EFB 122 may be situated onboard, in a portable manner or integrated into the cockpit. The said EFB can interact (bilateral communication 123) with the avionics equipment 121. The EFB can also be in communication 124 with external computing resources, accessible by the network (for example cloud computing 125). In particular, the computations can be performed locally on the EFB or partially or totally in the computation means accessible by the network. The onboard equipment 121 is generally certified and regulated while the EFB 122 and the connected computing means 125 are generally not (or to a lesser extent). This architecture makes it possible to inject flexibility on the EFB 122 side while ensuring controlled security on the onboard avionics 121 side.

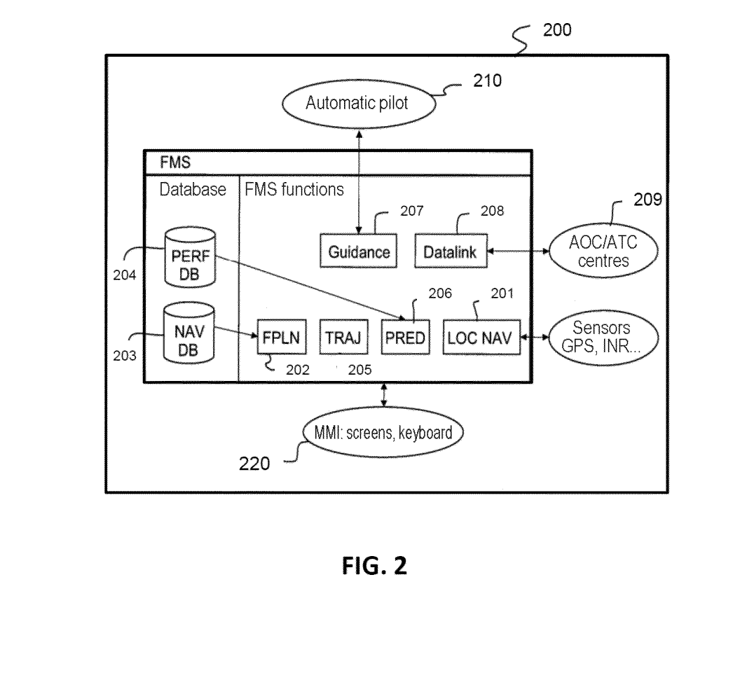

FIG. 2 schematically illustrates the structure and the functions of a flight management system of known FMS type. A system of FMS type 200 disposed in the cockpit 120 and the avionic means 121 has a man-machine interface 220 comprising input means, for example formed by a keyboard, and display means, for example formed by a display screen, or else simply a touch-sensitive display screen, as well as at least the following functions:
Navigation (LOCNAV) 201, for performing the optimal location of the aircraft as a function of the geolocation means 230 such as satellite-based geo-positioning or GPS, GALILEO, VHF radionavigation beacons, inertial platforms. This module communicates with the aforementioned geolocation facilities;
Flight plan (FPLN) 202, for inputting the geographical elements constituting the “skeleton” of the route to be followed, such as the points imposed by the departure and arrival procedures, the route points, the air corridors commonly referred to as “airways” according to the conventional terminology. The functions forming the subject of the present invention affect or relate to this part of the computer.
Navigation database (NAVDB) 203, for constructing geographical routes and procedures on the basis of data included in the bases relating to the points, beacons, interception or altitude legs, etc;
Performance database, (PERFDB) 204, containing the craft's aerodynamic and engine parameters;
Lateral trajectory (TRAJ) 205, for constructing a continuous trajectory on the basis of the points of the flight plan, complying with the performance of the aircraft and the confinement constraints (RNP);
Predictions (PRED) 206, for constructing an optimized vertical profile over the lateral and vertical trajectory and giving the estimations of distance, time, altitude, speed, fuel and wind notably over each point, at each change of piloting parameter and at the destination, and which will be displayed to the crew;
Guidance (GUID) 207, for guiding the aircraft in the lateral and vertical planes on its three-dimensional trajectory, while optimizing its speed, with the aid of the information computed by the Predictions function 206. In an aircraft equipped with an automatic piloting facility 210, the latter can exchange information with the guidance module 207;
Digital data link (DATALINK) 208 for exchanging flight information between the Flight plan/Predictions functions and the control centres or other aircraft 209.

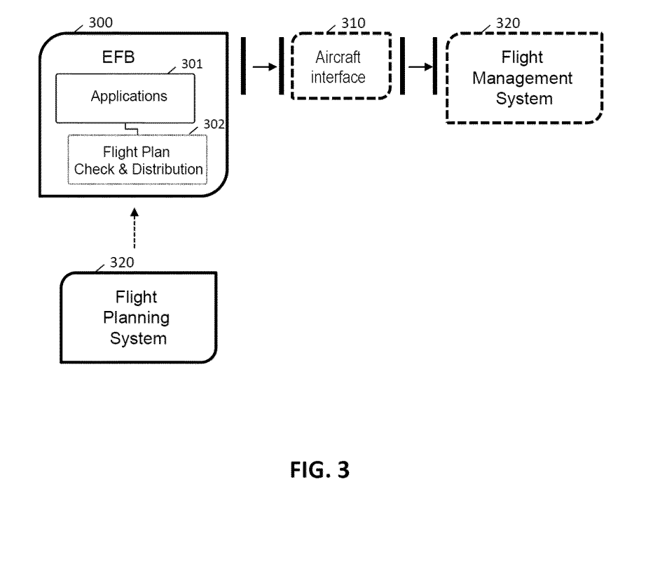

FIG. 3 presents an overall view and examples of steps of the method according to the invention. In one embodiment, the flight plan information is advantageously centralized within a device of EFB type 300. For example, a “Flight Plan Check & Management” function or application 302 (from among other functions or applications 301) called from such an EFB 300 can ensure diverse operations of managing the flight plan thus consolidated. In particular, the EFB can transmit, via the aircraft interface 310, the flight plan data, verified and processed, to the FMS 320 (onboard computer integrated into the aeroplane). The pilot consults the data and in return validates the various parts of the flight plan.

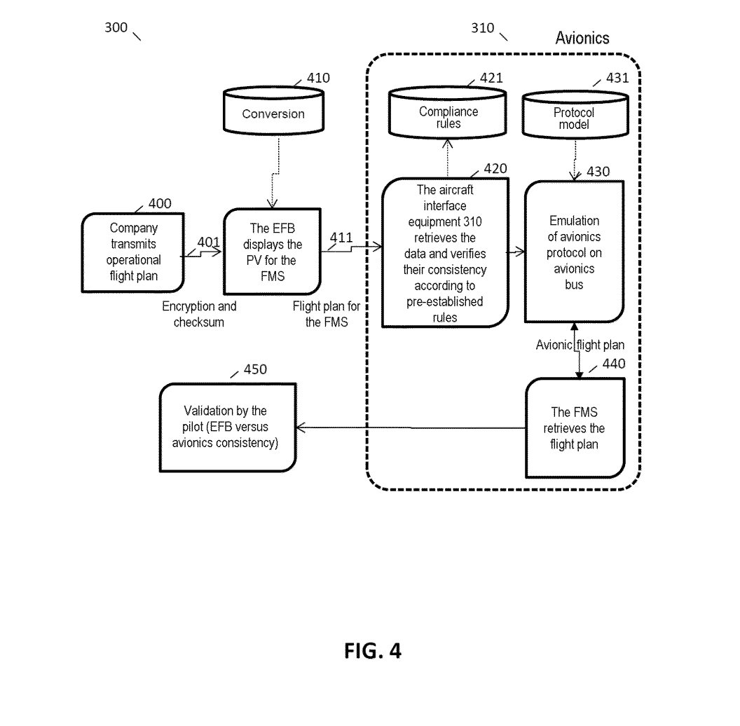

FIG. 4 details certain examples of steps of the method according to the invention. Illustrated in particular are the exchanges of information and the gateways between the certified and regulated avionics part 121 (FMS and interface equipment), shown diagrammatically by the dashes in the figure, and an “open” and uncertified technical environment (EFB & Flight Planning System). The figure stresses in particular the aspects relating to the security and to the integrity of the data reinjected into the avionics systems.

In step 400, the Flight System Planning (for example that of the airline company) transmits (for example via Wifi, 3G/4G or USB), the operational flight plan within the flight folder. The EFB system can for example include a “Flight Plan Check & Management” function which receives the ground data from this “Flight Planning System”, while ensuring the security (encipherment or encryption, secure protocol, authentication, etc), as well as the integrity of the data (checksum) and also, while ensuring that an operator can validate the request if required by the regulations. The manipulated data can be standardized (for example according to ARINC 633). They are generally in an XML type structured language format. The EFB collects and centralizes the initial data of the operational flight plan.

In step 401, the operational flight plan is enciphered and a hash value is computed (checksum).

In step 402, by means of a conversion file, the EFB displays the flight plan for the Flight Management System 200.

In step 410, the EFB deciphers the data and verifies the checksum. It displays the flight plan for the mission preparation and filters the data necessary for the Flight Management System (and/or transmits the pre-advised flight plan reference).

In step 411, the flight plan is transmitted to the FMS 200.

In step 420, the aircraft interface equipment 310 retrieves the data and verifies their consistency according to pre-established rules (for example so-called compliance rules 421). These rules for example verify the details of the flight plan, the existence and the relevance of the data, etc.

In step 430, the aircraft interface equipment 310 emulates a communication protocol of AGARS (air-ground communication) type, received from a protocol model 431, so as to transmit the flight plan in an avionics protocol and on an avionics bus.

In step 440, the Flight Management System retrieves the flight plan such as verified and validated by the certified avionics systems and proposes it to the pilot for validation, via the EFB. The pilot validates (or not, or partially) the new flight plan by ensuring the consistency of the data between those of the EFB and those arising from the avionics. In particular, a dedicated display on the EFB can also simulate the avionics equipment processing steps: the pilot can compare the data between those displayed on his EFB tablet 300 and those displayed on the avionics equipment 310.

The present invention can be implemented on the basis of hardware and/or software elements. It may be available in the guise of a computer program product on a computer readable medium. The medium may be electronic, magnetic, optical or electromagnetic. The computing means or resources can be distributed.

1. A computer-implemented method for managing data of an aircraft flight plan comprising the steps of:
collecting initial data of an operational flight plan from a flight planning system FPS by an electronic device of electronic flight bag EFB type;
verifying, filtering, converting and displaying by said EFB said initial data as a consolidated flight plan for the pilot;
communicating by said EFB said verified and converted data to the avionics system of the flight management system FMS, said FMS being able to compute an avionic flight plan on the basis of the converted data;
retrieving the avionic flight plan data such as processed by the flight management system FMS.

2. The method according to claim 1, the flight management system FMS verifying the security and/or the integrity of the converted initial data by means of predefined compliance rules.

3. The method according to claim 2, further comprising a step of avionics protocol emulation by the flight management system FMS so as to compute an avionic flight plan on the basis of the converted flight plan data.

4. The method according to claim 3, further comprising a step of comparing the avionic flight plan such as computed by the flight management system FMS with the operational flight plan initial data.

5. The method according to claim 4, the electronic device of electronic flight bag EFB type comprising display means and the comparison step of the method comprising the simulation and the display on the said electronic device of electronic flight bag EFB type of the avionic processing of the initial data of the operational flight plan.

6. The method according to claim 5, further comprising the reception of one or more modifications of one or more initial data of the operational flight plan.

7. The method according to claim 6, comprising the repetition of one or more steps from among the said steps of collection, conversion, retrieval, communication, comparison or of simulation.

8. The method according to claim 1, further comprising a step of enciphering the data before dispatch to the flight management system FMS.

9. The method according to claim 1, the electronic flight bag EFB being a computer tablet.

10. A computer program product, comprising code instructions making it possible to perform the steps of the method according to claim 1, when the said program is executed on a computer.

11. A system comprising means for implementing one or more steps of the method according to claim 1.
